(19) United States
(12) Patent Application Publication
(10) Pub. No.: US 2012/0218084 A1
(43) Pub. Date: Aug. 30, 2012

(54) METHOD AND APPARATUS FOR PRESENTING PRINTED MEDIA BASED ON RADIO FREQUENCY MEMORY TAG DETECTION

(75) Inventors: Jarmo Tapani Arponen, Espoo (FI); Jari-Jukka Harald Kaaja, Jarvenpaa (FI); Jyri Juhani Hämäläinen, Helsinki (FI)

(73) Assignee: Nokia Corporation, Espoo (FI)

(21) Appl. No.: 13/072,390

(22) Filed: Mar. 25, 2011

Related U.S. Application Data
(60) Provisional application No. 61/446,875, filed on Feb. 25, 2011.

(51) Int. Cl. H04Q 5/22

(52) U.S. Cl. 340/10.5; 340/10.1

(57) ABSTRACT

An approach is provided for associating content information with a radio frequency (RF) memory tag related to one or more items. One or more RF memory tags for maintaining additional information are associated with the one or more items. A data association platform causes, at least in part, a capture of content information from printed media. The data association platform then processes the content information to determine one or more items. A portion of the content information, additional information, or combination thereof is determined to be presented on reading of one or more RF memory tags.

### RELATED APPLICATIONS

This application claims the benefit of the earlier filing date under 35 U.S.C. §119(e) of U.S. Provisional Application Ser. No. 61/446,875 filed Feb. 25, 2011, entitled “Method and Apparatus for Presenting Printed Media Based on Radio Frequency Memory Tag Detection,” the entirety of which is incorporated herein by reference.

### BACKGROUND

Wireless (e.g., cellular) service providers and device manufacturers are continually challenged to deliver value and convenience to consumers by, for example, providing compelling services, applications, and content. One area of development is the integration of digital information and services with tangible objects (e.g., printed media, clothing, products, etc.) and their delivery channels (e.g., mail delivery, kiosks, stores, etc.). With the development of low-cost radio frequency (RF) memory tags that can be associated with any object, direct links between a tagged object and digital information can be created. Therefore, there is a need for an approach to efficiently and quickly detect RF memory tags (e.g., high memory capacity near field communication (NFC) tags or other wirelessly powered RF memory tags) associated with previously detected tagged objects. In the absence of this ability, wireless device users are unable to associate content information, such as that related to printed media, with a RF memory tag read for one or more other items.

### SOME EXAMPLE EMBODIMENTS

According to one embodiment, a method comprises causing, at least in part, a capture of content information from printed media. The method also comprises processing and/or facilitating a processing of the content information to determine one or more items. The method further comprises determining to present at least a portion of the content information, additional information related to the one or more items, or a combination thereof on reading of one or more radio frequency (RF) memory tags associated with at least one of the one or more items.

According to another embodiment, an apparatus comprising at least one processor, and at least one memory including computer program code, that at least one memory and the computer program code configured to, with the at least one processor, cause the apparatus to cause, at least in part, a capture of content information from printed media. The apparatus is also caused to process and/or facilitate a processing of the content information to determine one or more items. The apparatus is further caused to determine to present at least a portion of the content information, additional information related to the one or more items, or a combination thereof on reading of one or more RF memory tags associated with at least one of the one or more items.

According to another embodiment, a computer-readable storage medium carrying one or more sequences of one or more instructions which, when executed by one or more processors, cause an apparatus to cause, at least in part, a capture of content information from printed media. The apparatus is also caused to process and/or facilitate a processing of the content information to determine one or more items. The apparatus is further caused to determine to present at least a portion of the content information, additional information related to the one or more items, or a combination thereof on reading of one or more RF memory tags associated with at least one of the one or more items.

According to yet another embodiment, an apparatus comprises means for causing, at least in part, a capture of content information from printed media. The apparatus also comprises means for processing and/or facilitating a processing of the content information to determine one or more items. The apparatus further comprises means for determining to present at least a portion of the content information, additional information related to the one or more items, or a combination thereof on reading of one or more RF memory tags associated with at least one of the one or more items.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1A is a diagram of a system capable of associating content information, such as that related to printed media, with a RF memory tag read for one or more items, according to one embodiment;

FIG. 1B is a diagram of components of a data association platform, according to one embodiment.

FIGS. 2A and 2B are components of a tag-based content module and diagrams of components of a services platform, according to various embodiments;

FIGS. 3A and 3B are flowcharts of a process for associating content information, such as that related to printed media, with a RF memory tag read for one or more items, according to various embodiments;

FIGS. 4A-4F and 5 are diagrams of user interfaces utilized in the processes of FIGS. 3A and 3B, according to various embodiments;

FIG. 6 is a diagram of hardware that can be used to implement an embodiment of the invention;

FIG. 7 is a diagram of a chip set that can be used to implement an embodiment of the invention; and

FIG. 8 is a diagram of a mobile station (e.g., handset) that can be used to implement an embodiment of the invention.

### DESCRIPTION OF SOME EMBODIMENTS

A method and apparatus for associating content information, such as that related to printed media, with a radio frequency (RF) memory tag read for one or more other items are disclosed. As used herein, the term “item” refers to any object that can be associated with an electronic RF memory tag including printed media (e.g., books, magazines, newspapers, catalogs, advertisements, billboards, and the like), clothing, products, household items, electronic devices, etc. Additionally, the printed media may be interpreted, acquired or captured as content information by one or more audio, video, graphical or textual data capturing tools. For the purpose of illustration, printed media may comprise one or more of the above described items or portions thereof—i.e., one or more pages of a magazine or book. As used herein, content information is any data that is associated with or representative of the item, including a symbol, code, text string, audio or video data, etc. It is noted that a radio frequency (RF) RF memory tag may be captured, or in some instances, read by way of various data capturing or reading tools for being maintained as content information.

In the following description, for the purpose of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

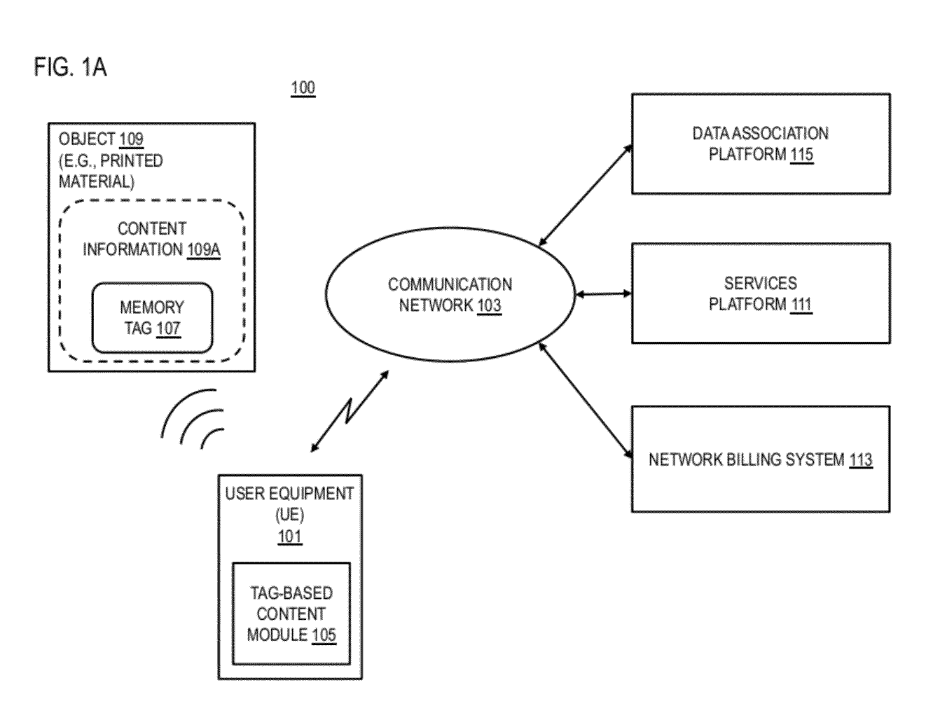

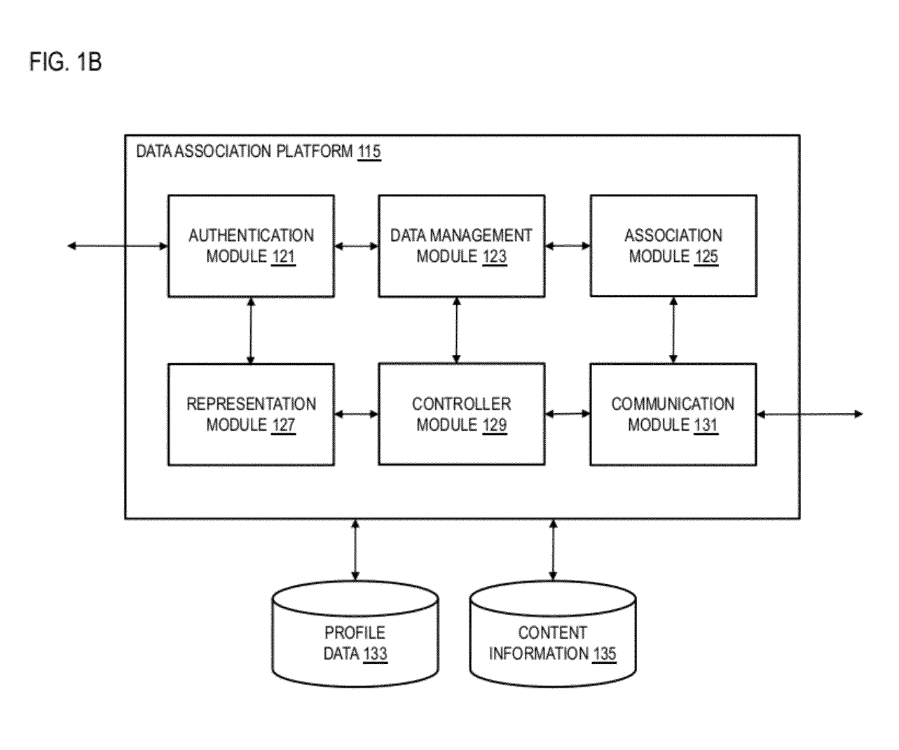

FIG. 1A is a diagram of a system capable of associating content information, such as that related to printed media, with a RF memory tag read in association with one or more items, according to one embodiment. Historically, tangible items (e.g., products, printed media, etc.) have well established means of distribution (e.g., stores, kiosks, etc.) that extend beyond the reach of electronic information transmitted over public networks (e.g., the Internet, telephone systems). For example, printed media has been the most widely used form of information because they are easy to use, produce and distribute. They may also vary in style or function to accommodate different user settings, often being provided by retailers, service providers or others in the form of advertisements, articles, banners, posters, magazines, flyers, mailers, informational, etc. Unfortunately, most people have difficulty recalling the specific details of any one printed media, let alone, the several different printed media they may encounter over a given period of time.

For example, an advertisement for one or more items available for purchase by a user at a specific retail store may include details of a promotional offer, product features, diagrams, user reviews, retailer information, product comparisons, purchase and pricing information and other information related to the one or more items. Without having access to the advertisement on demand, however, users are typically incapable of recalling all or any of these details. At best, they may be able to recall a few details pertaining to the item or retailer, but not enough information for enabling them to heed the advertisement and take advantage of the offer. This is especially true when much time has elapsed since the moment of first viewing of the printed media item—i.e., the usefulness and relevance of the data is subject to expiration. While the user may attempt to deduce details of the printed media by performing an Internet query or other type of search, this effort is can be time consuming or even unproductive in cases where the user has no useful query data to provide (e.g., they cannot remember any useful details conveyed in the printed media). Even when the user visits the location, store or service provider in question, they have no convenient or effective way to readily associate items available for purchase at that location with the printed media they viewed on a prior occasion.

The system 100 of FIG. 1A addresses this problem by associating content information, such as that captured from printed media, with a RF memory tag associated with one or more items. By way of example, the RF memory tag has sufficient memory to store additional information (e.g., text, video, still pictures, voice media, web links, databases, documents, software, purchasing data, product data, store data, etc.) about its associated object. In certain embodiments, the additional information may also include data pertaining to, or able to be processed for, generating or acquiring the following type of information: (1) data for indicating an association between respective content/media; (2) a delta value indicative of when an association is determined or applied (e.g., from print media, print media-digital media such as local RF memory tag); and (3) data for indicating an association between (1) and (2). Under this scenario, the delta value may be representative of a time elapsed between capturing print media content (yesterday) and digital content read from an RF memory tag at a current location (today). It is noted that the additional information may be any data for providing additional detail for associating printed media with read information from a RF memory tag.

In one embodiment, a user device (e.g., a mobile telephone equipped with a tag reader and/or writer, mobile reader/writer) detects the RF memory tag associated with an item, reads the additional information from the RF memory tag, correlates content information pertaining to the printed media as captured by the device to the additional information based on a recognition engine or other data matching or correlation mechanism (e.g., optical pattern recognition, audio recognition, voice recognition, text matching algorithm), and enables the user to view a representation of the associated printed media from the display of the device. It is noted that the system 100 is configured to enable the capturing and subsequent storing of content information, as captured by a user device, for generating a content information repository for storing previously captured content information associated with various printed media.

In one embodiment, system 100 also enables users to initiate various actions in response to the recalling of, or generation of, the representation of the printed media, which may include content information, additional information, real-time or user customized information, or a combination thereof. The actions include initiating a purchase, reserving an item, checking an item inventory, initiating execution or registration of an item, performing an item comparison, initiating an Internet query, initiating execution of a media file, creating a reminder for a delayed action, or a combination thereof. The above described actions may be implemented as services enabled for execution by a user device based on configuration settings, capabilities and data made available by the retailer, service provider, wireless communication services provider, user or a combination thereof. As used herein, the term “services” includes services, applications, content, or the like. It is noted that system 100 enables the seamless association and identification of printed media with respect to digital content (additional information) maintained at respective RF memory tags.

In certain embodiments, system 100 facilitates user interaction with the one or more RF memory tags for accessing content information and additional information according to user-specified preferences. For example, a user profile may specify what types of information to present (e.g., a first user specifies that the user is interested only in pricing information whereas another user specifies an interest only in seeing technical information). The technical information may include comparison charts, user recommendations, product or service ranking information, etc., all or which may be searchable by place, brand, shop, or the like.

Hence, it is noted that the additional information may be selectively generated and provided based on user defined preferences. Furthermore, the additional information as maintained by a tag may be selectively withheld or adapted (e.g., not presented) based on user profile data and preferences indicated, i.e., enabling presentment of only real time pricing information instead of outdated pricing data as indicated on previously viewed printed media.

For the purpose of illustration, when a user is reading a printed catalog that features items available for purchase and associated RF memory tags, the user can detect the RF memory tag (e.g., as affixed to various pages of the catalog) with an embedded tag reader of the mobile device. In this way, the user is able to read and interpret the additional information from the respective tag. In addition, or alternatively, the user may capture an image of a portion of the printed catalog, a banner or the physical store location, including a symbol, phrase, company name or logo, image of the RF memory tag, kiosk, storefront, service mark, code or any other sections of the printed media by way of the user device's embedded camera. The camera 211 may be configured to capture a live streaming image of the printed media 109 or may capture individual images at predetermined time intervals (e.g., every second or every 5 seconds). Upon reading of the RF memory tag or the capturing of the images, the data is stored to a content information database as maintained by a data association platform 115. It is noted, by way of this approach, that the user is able to maintain a note, bookmark, or other reference or indicator for enabling subsequent recall of the printed media or information pertaining to the items at a later time.

Having captured content information related to the printed media—whether by way of reading or acquiring data—the user can associate the content information with RF memory tags affixed to, or within range of the items corresponding to the catalogue. By way of example, when the user visits the store location of the retailer that produced the catalogue, the user may tag, touch or otherwise make contact with the tag in order to cause reading of the additional information maintained by the tag. The additional information may then be matched to the aggregated content information, with an affirmative match indicating a previously viewed instance of the printed media has been found and/or generated accordingly for presentment to the user.

As shown in FIG. 1A, system 100 comprises a user equipment (UE) 101 having connectivity to a communication network 103. The UE 101 is any type of fixed terminal, mobile terminal, or portable terminal including desktop computers, laptop computers, handsets, stations, units, devices, multimedia tablets, Internet nodes, communicators, Personal Digital Assistants (PDAs), mobile phones, mobile communication devices, digital camera/camcorders, audio/video players, positioning devices, game devices, televisions, and/or the like, or any combination thereof. It is also contemplated that the UE 101 can support any type of interface to the user (such as “wearable” circuitry, etc.) and includes a RF memory tag reader, a camera, or other similar input/output (IO) component. The UE 101 includes a tag-based content module 105 to enable interaction with a RF memory tag 107 associated with an object 109 (e.g., printed media) as described herein. For the purpose of example, the UE may be referred to synonymously with a user device (e.g., wireless communication device).

In various embodiments, the RF memory tag 107 is a near field communication (NFC) tag, radio frequency identification (RFID) tag, contactless card, a wirelessly powered RF memory tag, or the like that includes sufficient memory to store information related to the object 109. It is contemplated that the RF memory tag 107 may also be any similar wirelessly powered RF memory tag. The RF memory tag 107, for instance, is associated (e.g. embedded in, attached to, or printed on) any of a variety of objects capable of supporting the tag (e.g., packaging material, a sticker, a poster, a card, a magazine, a newspaper, products, clothing etc.). For example, a RF memory tag 107 associated with a piece of clothing may provide laundry instructions or links to local dry cleaners. As another example, a RF memory tag 107 associated with printed media, whether physically or digitally rendered, may include links for downloading a presentation, audio file or other media file. The object 109 may be generated for print or digital representation based on aggregation of various content information 109a, including data regarding the RF memory tag.

By way of example, NFC, RFID, contactless card, and similar technologies are short-range wireless communication technologies that enable the exchange (e.g., both reading and writing) of data between devices and tags over short distances (e.g., the range for NFC is approximately 4 inches). In general, these technologies comprise two main components, a tag (e.g., attached to an object) and a reader/writer (which can be implemented within the UE 101). Communication between the reader/writer and the tags occur wirelessly and may not require a line of sight between the devices. The tag (e.g., an RFID transponder) is, for instance, a small microchip that is attached to an antenna. The tags can vary in sizes, shapes, and forms and can be read through many types of materials. Moreover, the tags may be passive tags or active tags. Passive tags are generally smaller, lighter, and less expensive than active tags. Passive tags are only activated when with the response range of a reader/writer. In other words, passive tags are typically RF memory tags that are wirelessly powered by the reader/writer. The reader/writer emits a low-power radio wave field that is used to power the tag so as to pass on any information that is contained on the chip. Active tags differ in that they incorporate their own power source to transmit rather than reflect radio frequency signals. Accordingly, active tags enable a broader range of functionality like programmable and read/write capabilities. The read/write capabilities of the RF memory tag 107 can, for instance, enable the system 100 to write comments for storage in the RF memory tag 107 for retrieval by other users or update the content of the RF memory tag 107 to include the latest content. For example, a RF memory tag 107 associated an advertisement can be updated to contain the latest pricing and availability information.

A reader/writer typically contains a transmitter, receiver, control unit, and an antenna. In addition, the reader/writer may also feature several bytes (e.g., gigabytes) of non-volatile memory such as phase changed memory (PCM) or the like for maintaining data. The reader/writer performs several primary functions: energizing the tag, demodulating and decoding the returned radio signal, and providing clock information. In certain embodiments, a reader/writer includes an additional interface to convert the returned radio signal to a form that can be passed to another system such as a computer or programmable logic controller. As discussed previously, the RF memory tag 107 may be decoded and interpreted to reveal additional information regarding the object 109 including text, videos, pictures, audio files, databases, documents, software, and the like. In certain embodiments, the additional information also includes links, pointers or reference data to online content. This enables the RF memory tag 107 to reference dynamically updatable content such as a web page that provides time sensitive information, real-time data, dynamically driven data or the like.

Also, in certain embodiments, the RF memory tag 107 may require specific access codes to be conveyed before allowing the UE 101 to read the additional information from the RF memory tag 107. In one embodiment, the code may be checked automatically through, for instance, the services platform 111. In this way, the contents of the RF memory tag 107 may be restricted only to authorized users. For example, a tag-enabled magazine may restrict access to additional information to subscribers only by requiring an access code. Subscribers would be provided with the proper access code to access the RF memory tag 107 while others would not have access. The provided access code may be stored in a user profile or the services platform 111 for automatic retrieval and use. In other instances, the subscriber may be given access credentials at a time of visiting the retailer, such as by touching the RF memory tag associated with a product; the credentials being provided to entice the subscriber to make the purchase. Under this scenario, all users have access to the printed media 109 but only subscribers would have access to additional digital information.

This approach also extends to enablement of an access point, such as provided by a retailer at a store location where one or more items featured in printed media are available for purchase. In certain embodiments, user device interaction with RF memory tags 107 associated with the items may be restricted to users whose profile information grants them use of the store's wireless access point (WAP). The WAP may be any device (e.g., a router) that allows wireless devices, such as the user device 101, to connect to the store's communication network using Wi-Fi, Bluetooth or related standards. Profile based WAP access may be implemented as a security measure by the store, such as to enable advanced monitoring of customer activity, provide a means of theft or loss prevention, item tracking and other tasks. Alternatively, hotspot or Internet access may be facilitated based on the proper profile settings.

By way of example, the communication network 103 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), the Internet, or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, mobile ad-hoc network (MANET), wireless personal area network (WPAN), short range radio networks, and the like.

As shown in FIG. 1A, the UE 101 has connectivity to a services platform 111, such as OVI.com and OVI Store, a network billing system 113 and a data association platform 115 through the communication network 103. In exemplary embodiments, the services platform 111 provides services to support actions that may be related to the additional information contained in the RF memory tag 107 (e.g., providing access codes to the RF memory tag 107, registering a user, purchasing items, downloading software, etc.). In certain embodiments, the services platform 111 also interacts with the network billing system 113 to coordinate payment and billing for the services. The network billing system 113 is owned or served by, for instance, a service provider (e.g., cellular service provider) through which the user of the UE 101 has communication (e.g., wireless) service. Accordingly, the user of the UE 101 generally already has a billing relationship with the network billing system 113 and the associated service provider. It is contemplated that the network billing system 113 may also be owned by third party such as third party payment providers, like credit card service providers, banks, etc.

In addition, the data association platform may interact with the services platform 111 and network billing system 113 to provide users with the capability of recalling or generating, on demand, a representation of printed media related to one or more tagged items available for purchase. The data association platform 115 provides the representation in response to the reading of RF memory tags at the store location and the correlation of data provided therein with prior aggregated content information. It is contemplated that the services platform 111, network billing system 113 and data association platform 115 may be operated on the same platform or service.

By way of example, the UE 101 communicates with the other devices or components (e.g., the data association platform 115) on the communication network 103 using standard protocols. In this context, a protocol includes a set of rules defining how the network nodes within the communication network 103 (e.g., UE 101 and services platform 111) interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination/address, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

FIG. 1B is a diagram of components of a data association platform, according to one embodiment. The data association platform 115 includes various executable modules for performing one or more computing, data processing and network based instructions that in combination provide a means of enabling content information related to previously read printed media featuring one or more items to be associated with a RF memory tag for the one or more items. The modules can be implemented in hardware, firmware, software, or a combination thereof. By way of example, the data association platform 115 includes an authentication module 121, data management module 123, association module 125, representation module 127, controller module 129, and communication module 131. In addition, the data association platform 115 also accesses profile data from a profile database 133 for storing user profile data as well as a content information database 135 for maintaining content information captured by the user devices of various users. It is noted that access to content information of the various users may vary (e.g., show part, all or none) based on privacy rules and access credentials.

In one embodiment, an authentication module 121 authenticates users and user devices 101a-101n for interaction with the data association platform 115. By way of example, the authentication module 121 receives a request to subscribe to the service, as provided by a wireless communications service provider, for enabling the recall or generation of prior viewed printed media responsive to reading of RF memory tags. The subscription process may include enabling the reading of RF memory tags by the requesting device, such as based on profile data 133 (e.g., a password, access code, granted user privilege or status). The authentication module 121 also determines the credentials of a user and/or device attempting to utilize a wireless access point (WAP) maintained by a retailer at a store location, the location of a building for a business or any other location; the WAP being configured for regulation at that location by the services platform 111. Under this scenario, the authentication module 121 verifies and validates a password, user identification number, security code or any other value required for enabling access to the WAP. It is noted that the authentication module 121 may access profile data maintained for respective users (subscribers), including the selective recalling, pulling or searching of profile data 133 associated with a given user device that reads a RF memory tag.

In one embodiment, the authentication module 121 enables the accessing of profile information from one or more social networks associated with the user of the user device that reads the RF memory tags. By way of this approach, the data association platform 115 may provide for generation or recall of printed media based on data for indicating a user's group affiliations, social network status, or other information for characterizing a device user's interaction with other device users.

In one embodiment, a data management module 123 maintains content information as aggregated with respect to a user device (e.g., user equipment 101) in the content information database 135. The module 123 executes various functions for associating the content information with specific metadata such as context information (e.g., time data, location data, activity data) as generated by the device that captured the content information. In addition, the content information is maintained in connection with a specific user profile corresponding to the user device. By way of this approach, the content information may be readily recalled with respect to the user device, user or context thereof in to response to an applied search criteria.

In one embodiment, an association module 125 queries the content information database 135 in response to the reading of one or more RF memory tag by a user device. Additional information, as read from the tag, is provided to the association module 125 as input for enabling the query against the content information. In certain embodiments, the association module 125 employs a matching algorithm, indexer, pattern recognizer or other recognition engine or mechanism for processing the content information and the additional information. By way of example, the association module 125 may apply one or more of following recognition engine types:
Contextual: distribution-based, graph-based, color coding, structural, similarity structural propagation
Linguistic: similarity-based matching
Statistical: data type compatibility
Combined: pattern-based, heuristic analysis, rule-based matching.

In one embodiment, the representation module 127 generates a representation of the printed media item in response to the association of content information 135 with additional information as read from a tag. By way of example, the representation module 127 generates a version of the printed media in digital form that is presentable via a display of the user device. In certain embodiments, the printed media was originally captured or queried by the user prior to reading of a RF memory tag. In another embodiment, the printed media presented to the interface may be for an alternative or related item. As noted previously, the representation of the printed media may include content information, additional information or a combination thereof that is related to the one or more items related to the printed media or one or more other items.

The representation module 127 may also include various links for enabling the user to interact with the representation of the printed media as presented to a user display. For example, an action button, link, menu, text input field or other interactive commands or features may be provided to the user in connection with the printed media, such as to facilitate a purchase, check availability of a product or service, generate a comparison between items, reserve an item, perform a query, etc. The representation module 127 may operate in connection with the various APIs and/or software applications operable by a given user device to ensure execution of the association process (of module 125).

In one embodiment, a controller module 129 is configured to regulate the communication processes between the various modules. For example, the controller module 129 generates the appropriate signals to control the execution of a communication module 131, which provides the necessary interfaces for enabling data transmission over the communication network 103. In one embodiment, the communication module 131 also enables formation of a session over the network 103, such as for execution of a browser application of a user device. By way of example, the communication module 131 executes one or more protocols and data sharing techniques for enabling collaborative execution between respective user devices (e.g., mobile devices, laptops, smartphones, tablet computers, desktop computers) and the data association platform 115 over the network 103.

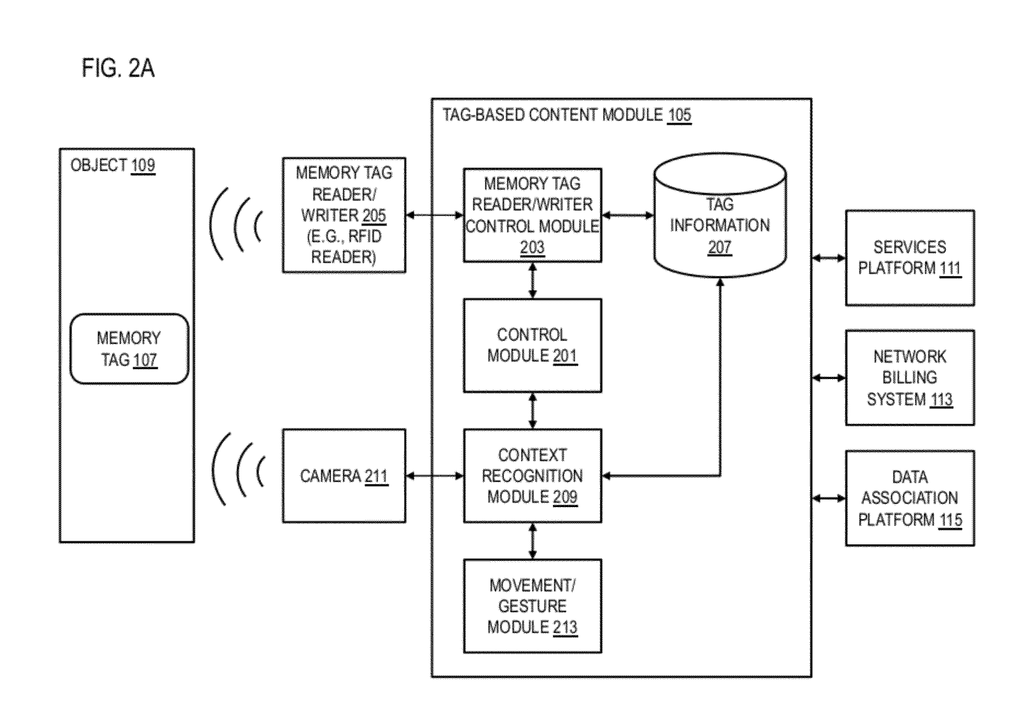

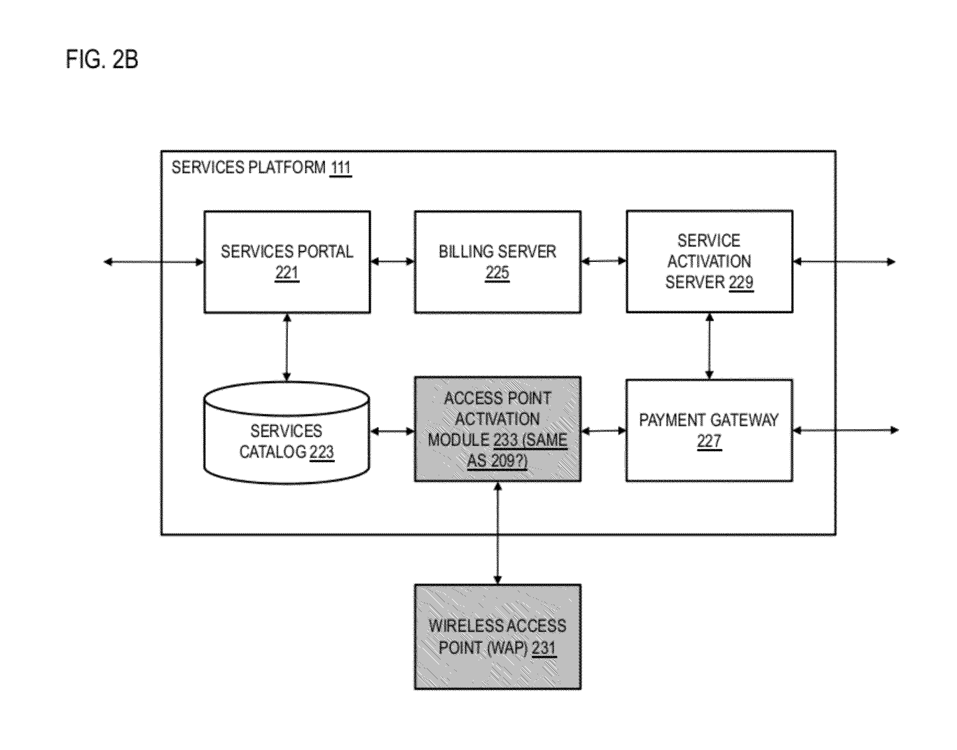

FIGS. 2A and 2B are diagrams of components of a tag-based content module and components of a services platform respectively, according to various embodiments. As shown in FIG. 2A, the tag-based content module 105 includes several sub-modules to enhance the object 109 with additional information from the RF memory tag 107. It is contemplated that the functions of the sub-modules may be combined or performed by other components or logic of the UE 101. In exemplary embodiments, the tag-based content module 105 includes a control module 201 for directing interaction with the RF memory tag 107 for obtaining additional information related to the object 109. The module 201 may, for instance, interact with a RF memory tag reader/writer control module 203 to detect user input for selecting the RF memory tag 107 in the printed media 109. By way of example, the user input may be indicated by tapping, touching or nearing the UE 101 towards the RF memory tag 107, i.e., tap UE 101 one or more times on, in the direction of or near the RF memory tag 107. The number of taps to initiate a request is configurable by the user, the service provider, or both. It is also contemplated that tapping includes bringing the UE 101 at least sufficiently close enough to the RF memory tag 107 so that the UE 101 can detect a return signal from the RF memory tag 107. A physical tap is not necessary. In addition or alternatively, the user can signal a request to select and read the RF memory tag 107 by activating one or more buttons or menu options on the UE 101, by otherwise causing the UE 101 to read the RF memory tag 107, or by any combination thereof.

After detecting the selection of the RF memory tag 107, the control module 201, for example, causes the RF memory tag reader/writer control module 203 to interact with an external RF memory tag reader/writer 205 (e.g., RFID reader/writer, NFC reader/writer, etc.). More specifically, the module 203, for instance, initiates the reader/writer 205 to download the additional information contained in the RF memory tag 107. In certain embodiments, the RF memory tag reader/writer is a component of the UE 101 (e.g., a handset with a built-in reader) in which the tag-based content module 105 resides. In other embodiments, the reader/writer 205 may be an external peripheral attached to the UE 101. Additionally, in cases where the RF memory tag 107 requires an access code, the control module 201 can provide the access code or request that the user enter the access code before initiating reading of the RF memory tag 107.

In one embodiment, the services platform 111 can provide the access code to the control module 201 automatically. The RF memory tag reader/writer control module 203 stores the read additional information in the tag information database 207. In one embodiment, the additional information includes information to associate the additional information with a specific section or portion of the object 109. The additional information may also include an electronic representation of the object 109 (e.g., an electronic version of a hardcopy magazine or catalog), one or more media files, one or more documents, one or more links to content, purchasing information, advertising information, an electronic catalog, or a combination thereof. If the RF memory tag 107 has write capabilities, the RF memory tag reader/writer control module 203 can direct the reader/writer 205 to write new information to the RF memory tag 107 including, e.g., writing comments by the user regarding the object 109 or updating the additional information stored in the RF memory tag 109. For example, the reader/writer 205 can write a user's review or notes on an item in tagged catalog for later reference. In another example, the reader/writer 205 can write a comment noting the last date that a coat associated with a RF memory tag 107 has been cleaned.

The control module 201 interfaces with a context recognition module 209 that receives image signal input from a camera 211 and a motion signal input from a movement/gesture module 213. In addition or alternatively, the movement may be detected by an accelerometer, radar technology, or another movement sensor. The context recognition module 209 processes the input to determine a context pattern, including a recurring location, activity, device function or mode, etc. The context information may be maintained for use by the data association platform 115 as metadata for associating the object 109 with a RF memory tag read for a related item.

FIG. 2B is a diagram of the components of a services platform, according to an exemplary embodiment. As shown in FIG. 2B, the services platform 111 includes several components to support actions or content initiated by the tag-based content module 105 based on the additional information read from the RF memory tag 107. It is contemplated that the functions of the components may be combined or performed by other components within the platform 111. In exemplary embodiments, the services platform 111 includes a services portal (e.g., store front) 221 for receiving service requests and delivering services to the UE 101. The services portal 221 has connectivity to services catalog database 223 containing information to identify the services that are appropriate for performing the actions or delivering the content requested by the tag-based content module 105. On receipt of a request for service, the services portal 221 interacts with the database 223 and billing system (e.g., server) 225 to determine user information (e.g., user identity, user profile, etc.) and/or the billing information (e.g., monthly fee, discounts, promotions, product cost, credit card number, bank account, credit point) associated with the received service request. In one embodiment, the services portal 221 uses the billing information to generate a message requesting confirmation of the service management request from the user.

On receipt of the user confirmation, the services portal 221, for example, directs the payment gateway 227 to collect the fees associated with the request. In exemplary embodiments, the payment gateway 227 may interact with the network billing system 113 to collect payment using, for example: (1) direct billing to the user using the International Mobile Station Identity (IMSI) associated with the user's UE 101, wherein the user's phone bill is directly charged for any fees and the payment gateway 227 makes a billing request to the network billing system 113 to recover the fees based on the IMSI; (2) direct billing using a 3G/GPRS access point, wherein the user's phone bill is directly charged for any fees and the payment gateway 227 makes a billing request to the network billing system 113 to recover the fees based the network assigned ID (e.g., a Mobile Subscriber Integrated Digital Services Network (MSISDN) number); (3) direct billing using a wireless access protocol (WAP) access point 231, wherein the user's phone bill is directly charged for any fees and the payment gateway 227 makes a billing request to the network billing system 113 to recover the fees based the network assigned ID (e.g., MSISDN) (i.e., WAP direct billing); (4) direct billing using WAP 231, wherein the user accesses a WAP portal to authorize payment against the user's phone bill and the payment gateway 227 makes a billing request to the network billing system 113 to recover the fees (i.e., WAP online billing); (5) direct billing using premium short message service (SMS) MO billing wherein an SMS sent from the user's device triggers direct billing against the user's phone bill and wherein the network billing system 113 sends the collected fees to the payment gateway 227 based on the SMS transaction identification; (6) direct billing using premium short message service (SMS) MT billing wherein an SMS sent to the user's device triggers direct billing against the user's phone bill and wherein the network billing system 113 sends the collected fees to the payment gateway 227 based on the SMS transaction identification; (7) direct billing against a prepaid account associated with the one or more services; (8) direct billing to a user account registered with the services portal 221 (e.g., the Nokia Ovi Store) wherein the payment gateway 227 makes a billing request against the form of payment (e.g., credit card) registered with the services portal 221; and (9) direct billing against a third party payment provider (e.g., credit card payment provider). In exemplary embodiments, the user, the service provider, or both can configure the payment mechanism used by the services platform 111.

It is noted that the WAP 229 may be enabled for user access by way of an access point activation module 233. In addition to facilitating the above described WAP functions, the access point activation module 233 may operate in connection with the data association platform 115 to verify user credential and profile information for enable access to the WAP.

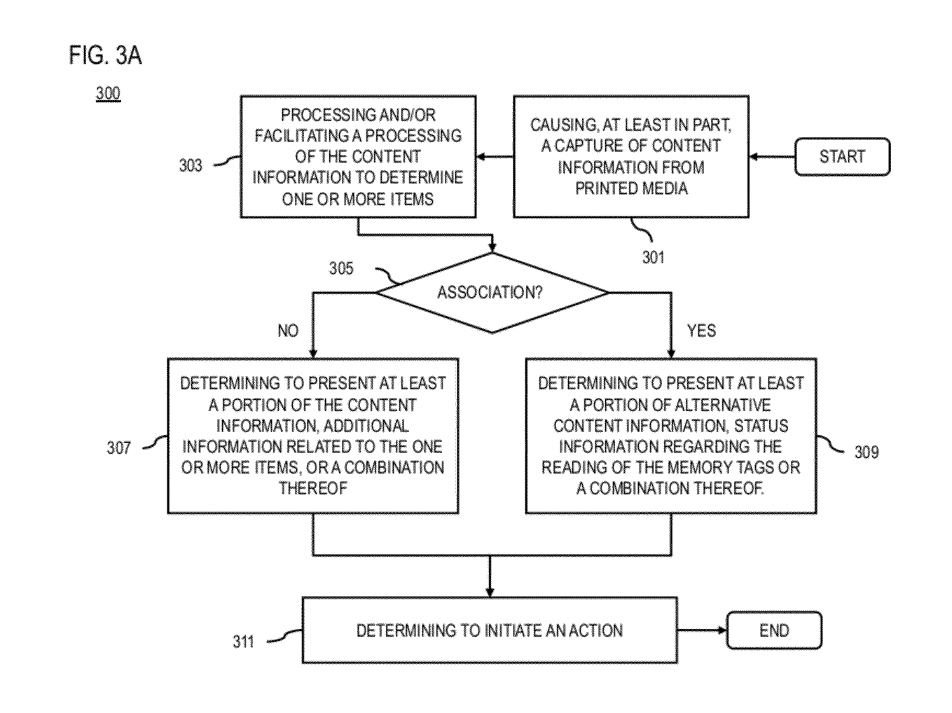

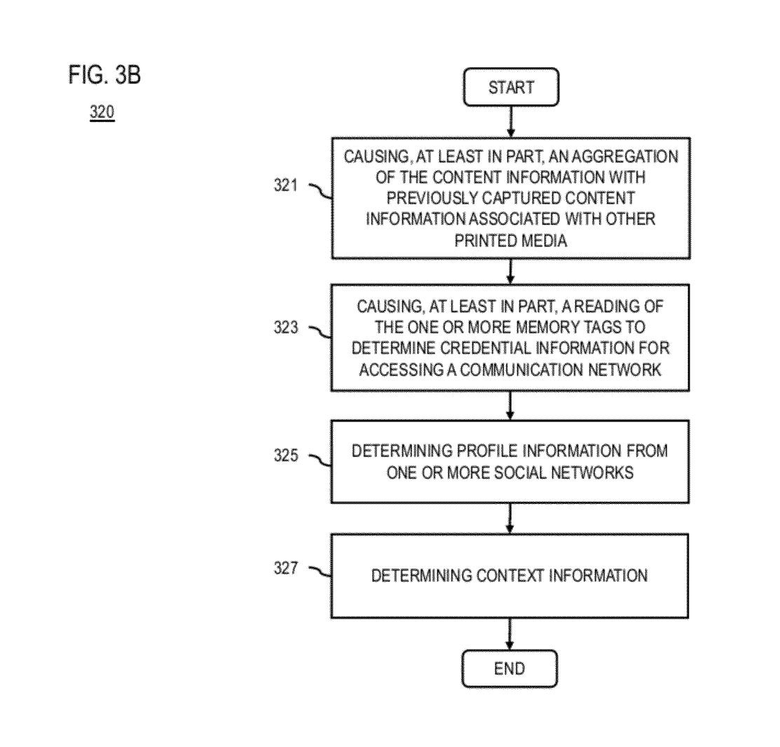

FIGS. 3A and 3B are flowcharts of a process for associating content information, such as that related to printed media, with a RF memory tag read for one or more items, according to various embodiments. For the purpose of illustration, the processes are described with respect to FIG. 1. It is noted that the steps of the process may be performed in any suitable order, as well as combined or separated in any suitable manner. In step 301 of process 300 in FIG. 3A, the data association platform 115 causes, at least in part, a capture of content information from printed media. As mentioned, the content information may include any data that is associated with or representative of the item, including a symbol, code, text string, audio or video data, etc.

In step 303, the data association platform 115 processes and/or facilitates a processing of the content information to determine one or more items. The one or more items may include a product, service or any other object for which the printed media is related or is the subject. Per step 305, the data association platform determines whether there is an association between the content information as captured and one or more RF memory tags featured with respect to one or more items. By way of example, the one or more RF memory tags may be featured in proximity to, or affixed to, one or more items made available by a retailer at a store location. The determination may be triggered by reading of the one or more RF memory tags to determine if the additional information conveyed can be matched to any content information stored by the data association platform.

When no association is determined between the additional information presented by the one or more RF memory tags and content information maintained by the data association platform 115, the platform 115 provides feedback or status information to the user by way of the display of the user device. Per step 309, the data association platform 115 determines to present at least a portion of alternative content information. In certain embodiments, the alternative content information may be data regarding one or more other items, including items not directly associated with the printed media, the one or more items or the retailer. Alternative content information may be presented in instances where no association is made, the associated content information is not relevant (e.g., out of date), or when other items are available by the retailer, by other users, user groups or otherwise that may be of interest to the user. In addition, the other items may be presented based on user profile data as maintained by the data association platform 115, including a shopping history, usage history, social network history or other details for indicating the behavior, preferences and interests of the user.

In step 307, when an association is determined between the additional information presented by the one or more RF memory tags and content information maintained by the data association platform 115, the platform 115 determines to present at least a portion of the content information, additional information related to the one or more items, or a combination thereof on reading of one or more RF memory tags associated with at least one of the one or more items. As mentioned previously, the content information and/or additional information may be processed to generate an electronic representation of the printed media as originally viewed by the user. In another step 311, the data association platform 115 determines to initiate one or more automated or user enabled actions. The actions include initiating a purchase, initiating a payment, initiating an Internet query, initiating a comparison, initiating a presentation of a media file, determining availability of the one or more items or other items, reserving the one or more items or other items, creating a reminder for a delayed action, or a combination thereof. It is noted that the actions may be presented to or executed from the user at a display of the user device in the form of various action buttons, menu options, content, etc.

In step 321 of process 320 in FIG. 3B, the data association platform 115 causes aggregation of the content information with previously captured content information associated with other printed media. As mentioned previously, the content information is maintained in a database that is progressively updated, respective to a given user or user device, as content information is read or captured by the device. A portion of the content information, the additional information, or a combination thereof is available for query from the database. It is noted that the query of the database may be performed due to the presence of a common indicator between the printed media and the one or more media tags. By way of example, the common indicator may include data representative of a service provider, retailer, advertiser, brand or manufacturer. It is contemplated that the common indicator may also be representative of events, activities, announcements, public works, projects and the like.

In another step 323, the data association platform 115 causes a reading of the one or more RF memory tags to determine credential information for accessing a communication network. As mentioned, this action is responsive to a requirement by a retailer or store location for enabling user interaction with a point-of-sale service, wireless access point or various RF memory tags by way of a user device. In certain embodiments, this action may be performed to configure a user device having limited or restricted wireless communication service or capability to gain access to a featured wireless access point. By way of example, when a user device is not configured to a communication network 103, credential provision and verification processing between the services platform 111 and the user device may be performed to enable network access. In certain embodiments, this action is carried out over the communication network (e.g., Bluetooth, WiFi). Credential information may include passwords, security codes, permission settings, user profile data, etc. A customer profile setting including a membership level, preferred shopper rating or other data may also be presented as credential information.

Per step 325, the data association platform 115 determines profile information for enabling the association between the previously viewed printed media and the one or more RF memory tags. Profile information may include data as extracted from, retrieved or detected from one or more social networks or in association with a device reading the one or more RF memory tags. The profile information may also include data pertaining to a user of the device, one or more other devices within the one or more social networks, one or more other users associated with the one or more other devices, or a combination thereof.

In step 327, the data association platform 115 determines context information associated with a device reading the one or more RF memory tags, a user of the device, the printed media, the one or more items, the one or more RF memory tags, or a combination thereof. As mentioned previously, the user device may be to capture or detect various sensory signal inputs that may be processed as context information. In certain embodiments, this information may be maintained as metadata for association with user profile information. It is noted that context information may be used, in connection with the reading of a RF memory tag, discovery of a wireless access point, detecting of the presence of one or more other user devices, or a combination thereof to further facilitate the initiation of actions. By way of example, in response to the reading of one or more RF memory tags placed on signs at a train station along with a detected ambient temperature value (e.g., as sensed by a temperature sensor of the user device) at a certain threshold, the user may be directed to the nearest water fountain or air conditioned or heated area of the station.

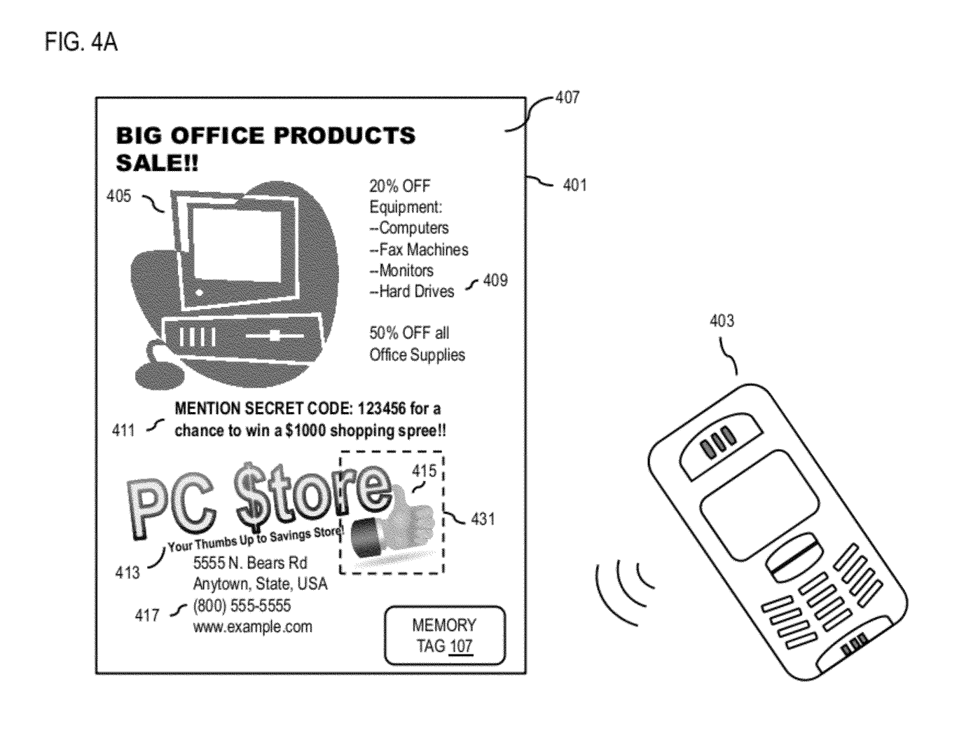

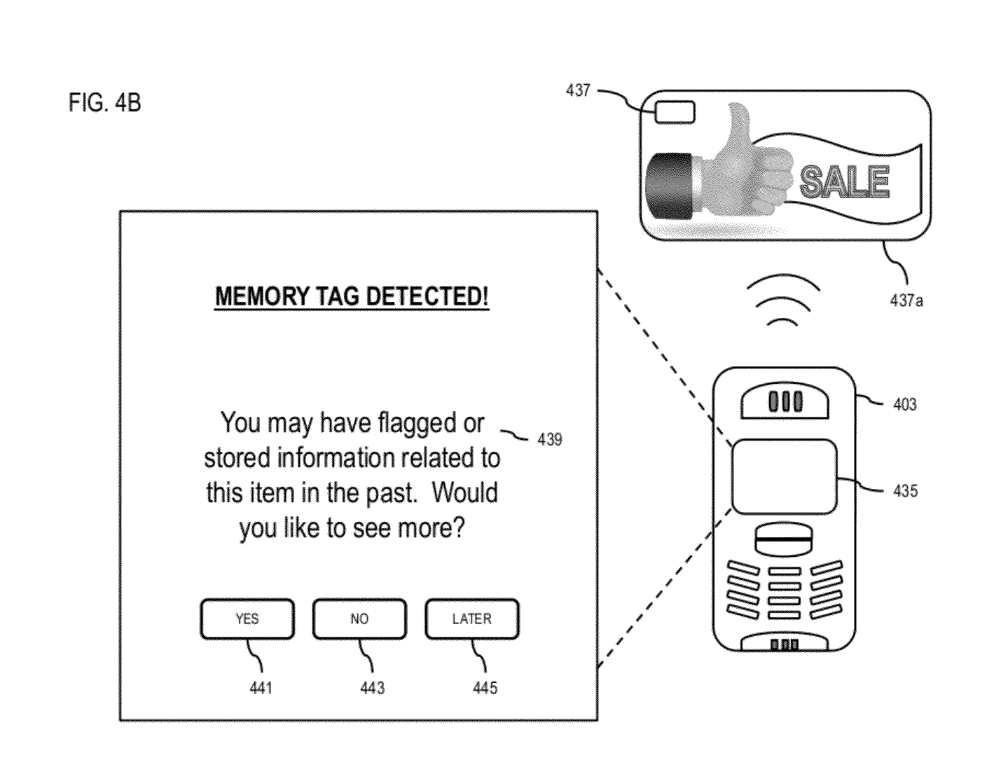

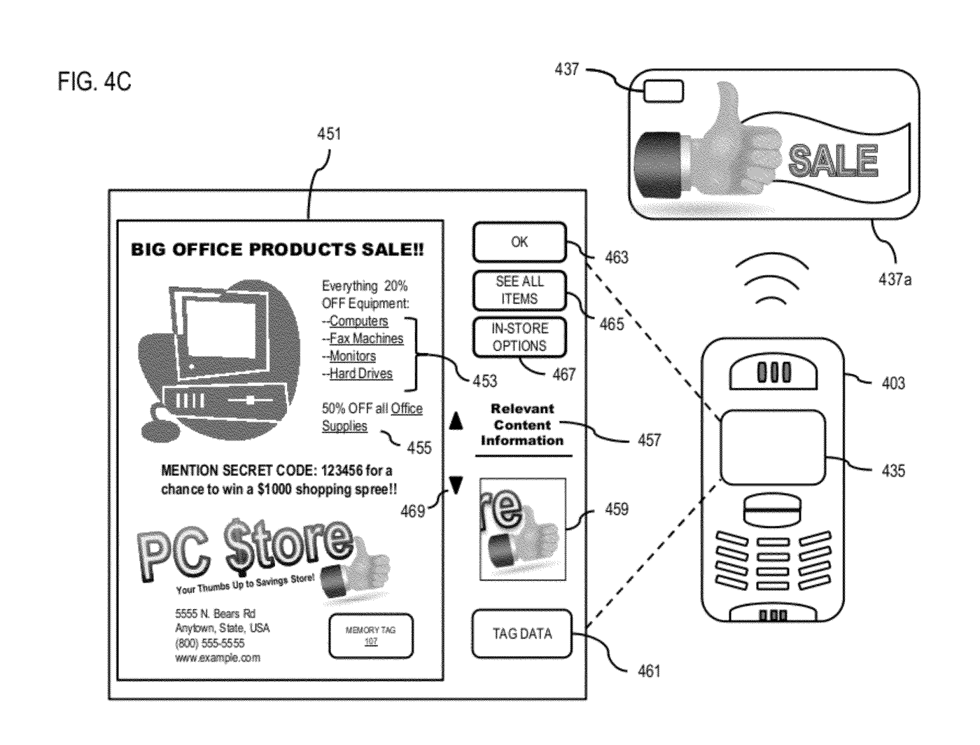

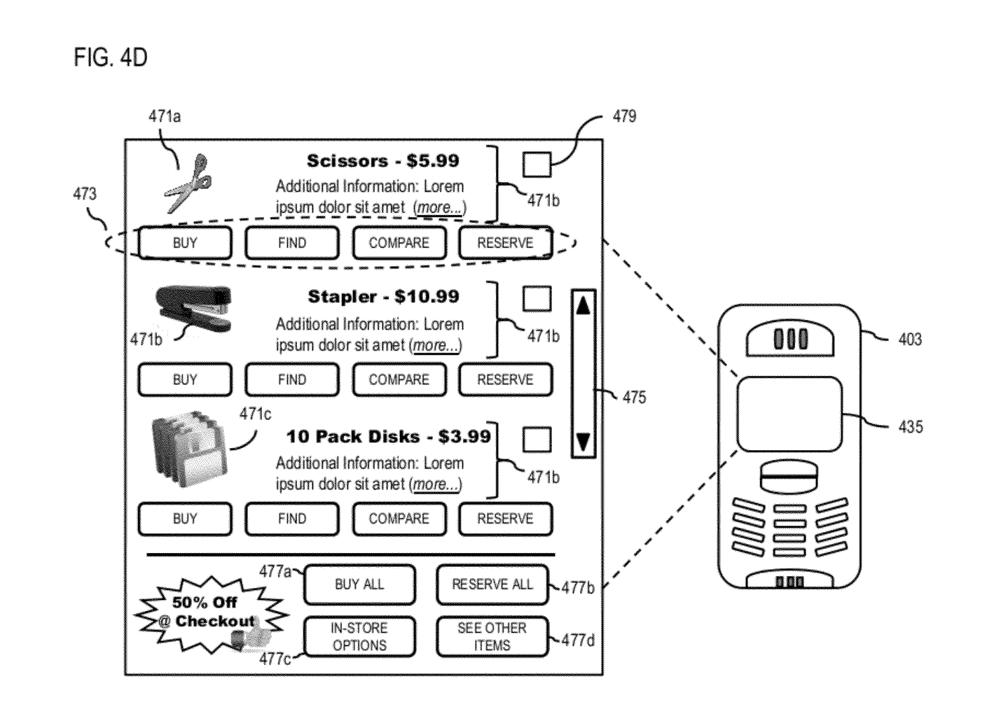

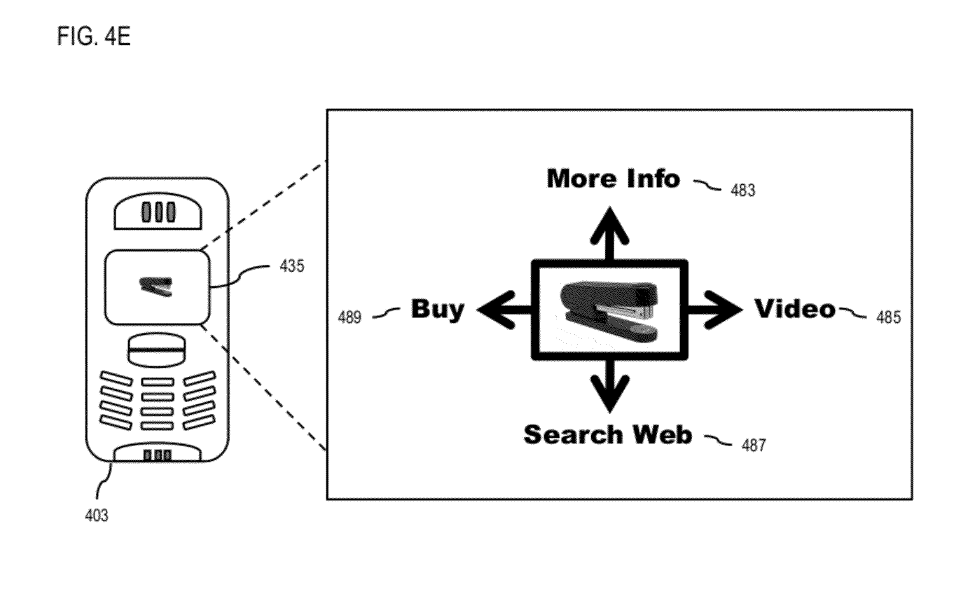

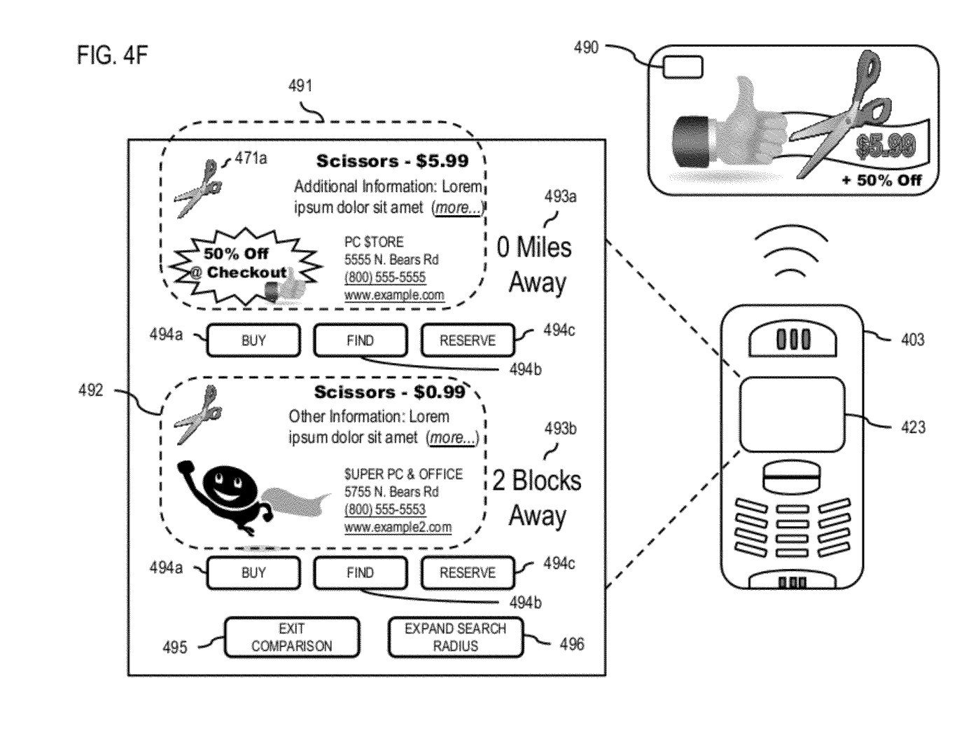

FIGS. 4A-4F are diagrams of user interfaces utilized in the processes of FIGS. 3A and 3B, according to various embodiments. For the purpose of illustration, the diagrams are described with respect to an exemplary use case of a mobile device user that observes and captures data pertaining to printed media 401 (e.g., an advertisement) created by a fictitious office products and equipment supplier (e.g., PC $tore). The user subsequently recalls the print media or a representation thereof based on reading of one or more RF memory tags at a later time. While presented herein as an advertisement, it is noted that printed media may include any item for displaying print (e.g., leaflets, brochures, stickers) and may also be employed for purposes other than retail.

In FIG. 4A, the printed media 401 includes various content, including: a graphic 405, an announcement 407, information 409 regarding one or more items (e.g., products) available for purchase, promotional offer details 411, a retailer brand name 413 and logo 415 and contact information 417 pertaining to the retailer. The advertisement announces a sales event relating to the one or more items, which in this case is office supplies and office equipment. A RF memory tag 107 is also affixed to the printed media 401 for enabling user interaction with the print media (e.g., accessing of additional information via a web link).

The user encounters the advertisement by way of a magazine article, poster, banner, billboard or any other means. For illustration purposes, the user's mobile device 403 is configured in the manner discussed with respect to user device 101 of FIG. 1 and FIG. 2A. As such, the user is able to read and/or capture content information as conveyed with respect to the printed media 401 by way of a tag reader, embedded camera of the device, or combination thereof. The camera may be suitable for supporting a wider range of data capture of the advertisement—close or short range, while the RF memory tag 107 is suited for closer range data capture. It is noted that while presented as an example, the printed media 401 may or may not be implemented with RF memory tags 107. The various embodiments presented herein contemplate operation of the mobile device 403 for capturing any content information, including that based on RF memory tags 107, symbols or other indicators representative of a given retailer, brand, item, etc.

Under this scenario, the user reads the details presented and decides to capture an image of a portion 431 of the advertisement, corresponding to the logo 415 of the retailer. The image, when stored to the mobile device 403, may be time stamped, named and organized with various other metadata for providing contextual details regarding the image. In addition, the user also reads the additional information provided by the RF memory tag 107, the additional information also capable of being stored or recorded by the mobile device. As described previously, the content information once captured is conveyed to the data association platform 115. The information is made available for query, in response to the reading of a corresponding RF memory tag at a later time. Of note, various functions presented with respect to the data association platform 115 may be performed at the mobile device, at an independently located platform server, or a combination thereof.

In FIG. 4B, an exemplary display/user interface 435 of the mobile device 403 for alerting the user of a read/detected RF memory tag 107 is shown. Under this scenario, the user visits a PC $tore location at a later time, i.e., several days after reviewing the printed media 401 of FIG. 4A. Also, the user is not able to recall the specific details of the printed media 401. In accord with the functionality described above in FIGS. 3A and 3B, the user tags, touches or comes within proximity of one or more RF memory tag 437 affixed to an in-store placard or sales sign 437a. In some instances, there may be two RF memory tags at the sign 437a, where one is for maintaining store related association data (e.g., data regarding an association between printed media and the tag) and another is for maintaining data regarding a specific section of the store or product/topical association data. Still further, all of this data may be integrated into a single tag (e.g., as additional information).

As mentioned, this triggers reading of the additional information provided by the RF memory tag. In addition, the data association platform 115 processes the read additional information, applicable context information and content information as stored; the processing including determining if an association exists between the data. Successful correlation results in presentment of a message 439 to the display 435 of the mobile device 403 for indicating a (potential) association has been identified.

One or more action buttons 441-445 are also presented for enabling the user to interact in accordance with the system 100. The “Yes” action button 441 allows the user to respond affirmatively to message 439 (e.g., to the data association platform 115) and proceed to view the stored content information or representation of the printed media that may be associated with the read RF memory tag 437. The “No” action button allows the user to cancel the message 439 and proceed with normal operations of the mobile device 403. The “Later” action button 445 allows the user to postpone review of the stored content information or viewing of the electronic representation of the printed media 401. For the purpose of illustration, the user selects the “Yes” action button 441, resulting in presentment of an electronic/digital representation of the printed media 401 to the display 435, as depicted in FIG. 4C. Additional information may also be presented to the screen for indicating a level or interest in the item (e.g., “Hot buy of the week”), conveying a color coding, highlighting of data, etc.

As a result of the association, a representation 451 of the printed media 401 is displayed to the display 435. Of note, the representation 451 is generated and/or recalled based on processing of the content information relating to one or more items (e.g., products available at PC $tore), additional information related to the one or more items, or a combination thereof. In certain embodiments, the representation is also based on the processing of context information associated with a device 403 reading the one or more RF memory tags 437, a user of the device, the printed media 401, the one or more items, the one or more RF memory tags, or a combination thereof. The representation 451 of the printed media 401 includes interactive content—i.e., buttons, links, actionable content—for allowing the user to execute various actions. By way of example, the representation 451 presents the item detail information 409 as one or more selectable links 453 and 455; the selection of a link 453/455 enabling the user to display additional information, options that are available to the user or actions capable of execution with respect to the specified items. This is discussed more fully later on with respect to FIG. 4D.

Action buttons 463-467 are also presented for enabling the user to respond to or interact with the data association platform 115. The “Ok” action button 463 enables a user to verify that the representation of the printed media 451 is correct. It is noted that the user may gather several pieces of information regarding different items at various moments. For example, while taking a bus, the user may capture an image of a billboard pertaining to a concert or an audio recording of a theme song or jingle for a product advertised during a radio broadcast. As another example, the user may capture a still image of a video or television broadcast that features jewelry of interest, or a scanned picture of a flyer for promoting an upcoming event. In each of these examples, regardless of the data acquisition or capture means employed, the content information may be stored and subsequently queried for associating the data with currently read RF memory tags. In instances where there are multiple potential matches, such as to within a degree of compatible determination, possibility, inconclusiveness, the respective print media representations may be scrolled through by the user (e.g., via scroll selectors 469). This is especially useful in instances where the user captured content information is varied albeit in reference to similar items (e.g., brands, services, products). It is noted that the scroll selectors may be active (appear) or inactive (hidden) depending on the whether there are multiple printed media representations available.

As another option, the user may select a “See All Items” action button 465 for enabling presentment of a display featuring all of the items available for purchase at the store, an inventory listing, or the like. As will be discussed further, the user may initiate an action for purchasing the item, reserving the item, generating a rain check request, accessing a network resource (e.g., WAP) and other actions. The “In-Store Options” action button 467 enables a user to be presented with various services, as provided by the services platform 111 in connection with the data association, that pertains to the specific vendor, retailer or store location the user is visiting (e.g., PC $tore). By way of example, PC $tore may feature a particular promotion, incentive, contest, announcement, etc. that is available exclusively for its customers, only the user, only that particular store location (e.g., not available at all store locations) or the like. Profile data may be relied upon for enabling execution of the in-store option. As another example, specific applications may be presented to the user for execution, including an application or service for generating an optimized shopping path corresponding the reading of one or more tags, an electronic rebate processor, a customized sales ad based on user profile settings and determined user context, etc.

Also featured to the display 435 is a relevant content information viewer 457, which corresponds to a portion of the user interface for presenting a view of the specific content information relied upon by the data association platform 115 to recall or generate a particular printed media representation. By way of this approach, the user is able to see what content information was used in connection with the reading of the one or more RF memory tags 437. For example, the representation of printed media 451 as shown to the display 435 is generated/recalled based, at least in part, on reading of the RF memory tag 437 and associating of the captured image data 431 and read tag data 461 with the RF memory tag 437. It is noted that the tag data may be presented textually for conveying the corresponding additional information acquired upon initial reading of the RF memory tag 107 of the printed media 401.

In FIG. 4D, exemplary display/user interface 435 of the mobile device 403 enables the user to browse through and select from one or more items available at the store location. For example, when the user selects the “Office Supplies” link provided as interactive content within print media representation 451 (FIG. 4C), a listing of various supplies (items) corresponding to the print media is shown. By way of example, the listing includes additional information pertaining to the items, including one or more graphics 471a-471c and corresponding textual data 471d-471f for describing the products (e.g., pricing information, product descriptions, product availability, etc.). The user may scroll through the selection by way of a scroll bar 475. Various action buttons 473 are also provided, including a “Buy,” “Find,” “Compare,” and “Reserve” buttons for enabling the user to buy, find (in the store), compare or reserve one or more items respectively.

Another portion of the interface 435 features additional action buttons 477a-477d, some of which enable the user to initiate or perform one or more actions with multiple items simultaneously. By way of example, the “Buy All” and “Reserve All” action buttons allow the user to initiate purchase or reserving of any items checked on the list via a checkbox option 479. Also, the “See Other Items” action button 477d enables the user to view other items or browse for other content, such as by way of the Internet. The “In-Store Options” action button 477c operates as described previously. It is noted that while the items presented to the display 435 of FIG. 4D is a list of all available items, this same interface may be presented in response to reading of individual tags for those items. For example, when the mobile device 403 reads a RF memory tag associated with the scissors 471a, stapler 471b and disks 471c, a listing of these items may be presented to the user as a current shopping cart view or the like.

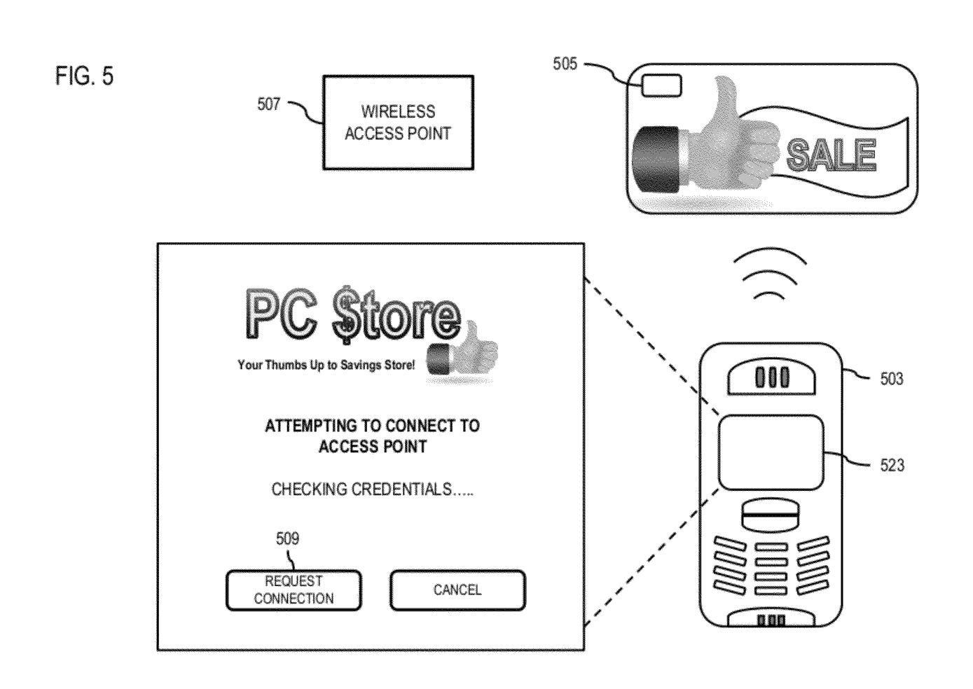

In FIG. 4E, exemplary display/user interface 435 of the mobile device 403 enables. In this example, the user of the mobile device 403 has selected the stapler 471b (e.g., a recognized item as shown in FIG. 5C). Accordingly, the display 435 presents the selected stapler 471b along with four actions or content associated with the stapler 471b. The display 435 presents four commands along with the direction to move the mobile device 403 to initiate the command. For example, to initiate the “More Info” action 483 to obtain more information about the stapler, the mobile device 403 can be moved in the forward direction. To initiate delivery of the video content depicting the stapler 417b, the mobile device can be moved rightward, enabling the “Video” action 485. To initiate the action to search the web for information about the stapler 417b, the mobile device 403 can be moved backward enabling the “Search Web” action 487. Also, to initiate the action to buy the stapler 417b, the mobile device 403 can be moved in leftward, enabling the “Buy” action 489. If the display 435 is touch-screen capable, the user may also indicate a menu choice by touching the area of the display corresponding to the choice. In addition or alternatively, the user may indicate a menu choice by using a direction pad, joystick, keyboard or other similar input device on the mobile device 403 (e.g., UE 101).

In FIG. 4F, exemplary display/user interface 435 of the mobile device 403 enables the user to perform an item, brand, store, price or other type of comparison based on reading of one or more RF memory tags. By way of example, when the user reads a RF memory tag 490 associated with a pair of scissors at the PC $tore, the user may select a “Compare” action button (e.g., as shown in buttons 473 of FIG. 4D) to engage a comparison of the item against the same item at other stores within a predetermined radius. The user may define the radius as part of their preferences, or in other instances, adapt the radius information dynamically. Under the exemplary comparison scenario, a portion 491 of the interface 435 presents the additional information about the scissors 471a, including details regarding the store location and web address, a logo associated with the PC $tore, a product description, a name and cost of the item, etc. Another portion of the interface 435 presents other information 492 about the scissors 471a. As mentioned previously, the other information 492 pertains to information not directly provided by or related to PC $tore. By way of example, the other information 492 relates to a different retailer named “Super PC & Office,” i.e., as extracted from external data sources available over the communication network 103.

The comparison shows that the same scissors 471a are available for $0.99 at Super PC & Office as opposed to $5.99 (plus 50% off) at PC $tore. In addition, the comparison includes distance information 493a and 493b for indicating a relative distance of the retailers respective to the current position/location of the user. Action buttons 494a-494c are also available to enable the user to buy, find or reserve an item featured in the comparison. For example, the distance information is retrieved when the user selects the “Find” action button 494b.

In FIG. 5, exemplary display/user interface 535 of the mobile device 503 enables the user to connect to a wireless access point (WAP) of a provider. Under this scenario, the provider is a retailer PC $tore. By way of example, when a user device 503 reads a RF memory tag 505 at the store location, credential information of the user or mobile device 503 is determined. Under this scenario, additional information maintained by the tag 505 is withheld from the user device, pending verification of the user's credentials. In certain embodiments, profile information for the user is automatically checked against required network permissions and access settings for enabling a connection to be formulated with the WAP 507. In another embodiment, responsive to reading of the RF memory tag 505, the display 523 presents a “Request Connection” action button 509 for enabling the user to initiate the connection process. Once the credentials are verified, the user is able to interact with the RF memory tag 505 and others throughout the store for accessing additional information.

The exemplary techniques and system presented herein enables device users to persistently aggregate content information that can be queried on demand and subsequently associated with one or more RF memory tags. In addition, the user is able to recall print media related to one or more objects based on the determining of an association between the one or more objects and the aggregated content information.

The processes described herein for associating content information, such as that related to printed media, with a RF memory tag read for one or more items may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

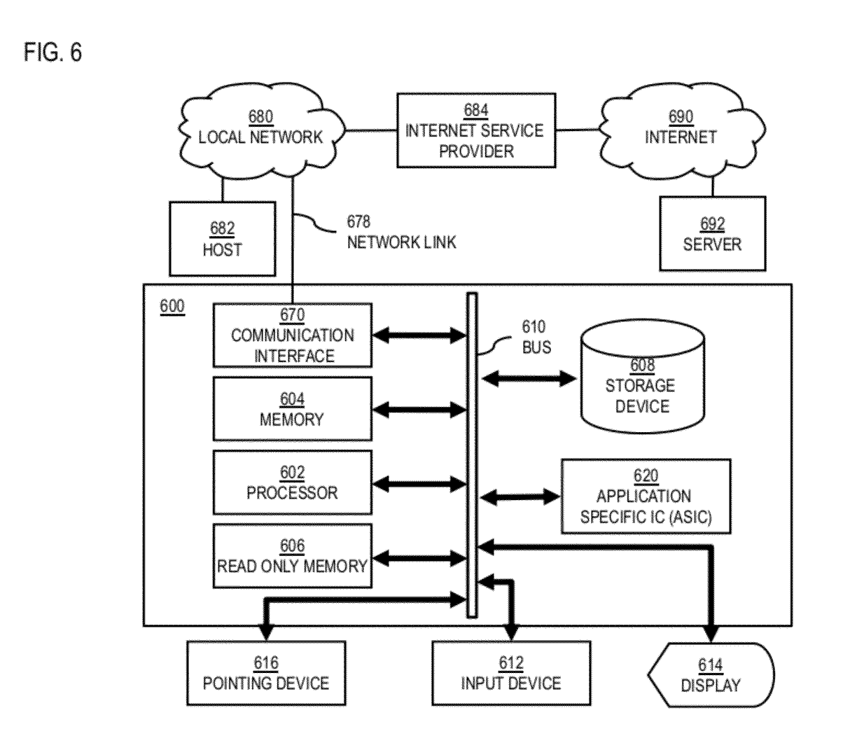

FIG. 6 illustrates a computer system 600 upon which an embodiment of the invention may be implemented. Although computer system 600 is depicted with respect to a particular device or equipment, it is contemplated that other devices or equipment (e.g., network elements, servers, etc.) within FIG. 6 can deploy the illustrated hardware and components of system 600. Computer system 600 is programmed (e.g., via computer program code or instructions) to associate content information, such as that related to printed media, with a RF memory tag read for one or more items as described herein and includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 600, or a portion thereof, constitutes a means for performing one or more steps of associating content information, such as that related to printed media, with a RF memory tag read for one or more items.

A bus 610 includes one or more parallel conductors of information so that information is transferred quickly among devices coupled to the bus 610. One or more processors 602 for processing information are coupled with the bus 610.

A processor (or multiple processors) 602 performs a set of operations on information as specified by computer program code related to associating content information, such as that related to printed media, with a RF memory tag read for one or more items. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 600 also includes a memory 604 coupled to bus 610. The memory 604, such as a random access memory (RAM) or any other dynamic storage device, stores information including processor instructions for associating content information, such as that related to printed media, with a RF memory tag read for one or more items. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or any other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions for associating content information, such as that related to printed media, with a RF memory tag read for one or more items, is provided to the bus 610 for use by the processor from an external input device 612, such as a keyboard containing alphanumeric keys operated by a human user, or a sensor. A sensor detects conditions in its vicinity and transforms those detections into physical expression compatible with the measurable phenomenon used to represent information in computer system 600. Other external devices coupled to bus 610, used primarily for interacting with humans, include a display device 614, such as a cathode ray tube (CRT), a liquid crystal display (LCD), a light emitting diode (LED) display, an organic LED (OLED) display, a plasma screen, or a printer for presenting text or images, and a pointing device 616, such as a mouse, a trackball, cursor direction keys, or a motion sensor, for controlling a position of a small cursor image presented on the display 614 and issuing commands associated with graphical elements presented on the display 614. In some embodiments, for example, in embodiments in which the computer system 600 performs all functions automatically without human input, one or more of external input device 612, display device 614 and pointing device 616 is omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of ASICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. For wireless links, the communications interface 670 sends or receives or both sends and receives electrical, acoustic or electromagnetic signals, including infrared and optical signals that carry information streams, such as digital data. For example, in wireless handheld devices, such as mobile telephones like cell phones, the communications interface 670 includes a radio band electromagnetic transmitter and receiver called a radio transceiver. In certain embodiments, the communications interface 670 enables connection to the communication network 103 for associating content information, such as that related to printed media, with a RF memory tag read for one or more items to the UE 101.

The term “computer-readable medium” as used herein refers to any medium that participates in providing information to processor 602, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 608. Volatile media include, for example, dynamic memory 604. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 620.

Network link 678 typically provides information communication using transmission media through one or more networks to other devices that use or process the information. For example, network link 678 may provide a connection through local network 680 to a host computer 682 or to equipment 684 operated by an Internet Service Provider (ISP). ISP equipment 684 in turn provides data communication services through the public, world-wide packet-switching communication network of networks now commonly referred to as the Internet 690.

A computer called a server host 692 connected to the Internet hosts a process that provides a service in response to information received over the Internet. For example, server host 692 hosts a process that provides information representing video data for presentation at display 614. It is contemplated that the components of system 600 can be deployed in various configurations within other computer systems, e.g., host 682 and server 692.

At least some embodiments of the invention are related to the use of computer system 600 for implementing some or all of the techniques described herein. According to one embodiment of the invention, those techniques are performed by computer system 600 in response to processor 602 executing one or more sequences of one or more processor instructions contained in memory 604. Such instructions, also called computer instructions, software and program code, may be read into memory 604 from another computer-readable medium such as storage device 608 or network link 678. Execution of the sequences of instructions contained in memory 604 causes processor 602 to perform one or more of the method steps described herein. In alternative embodiments, hardware, such as ASIC 620, may be used in place of or in combination with software to implement the invention. Thus, embodiments of the invention are not limited to any specific combination of hardware and software, unless otherwise explicitly stated herein.

The signals transmitted over network link 678 and other networks through communications interface 670, carry information to and from computer system 600. Computer system 600 can send and receive information, including program code, through the networks 680, 690 among others, through network link 678 and communications interface 670. In an example using the Internet 690, a server host 692 transmits program code for a particular application, requested by a message sent from computer 600, through Internet 690, ISP equipment 684, local network 680 and communications interface 670. The received code may be executed by processor 602 as it is received, or may be stored in memory 604 or in storage device 608 or any other non-volatile storage for later execution, or both. In this manner, computer system 600 may obtain application program code in the form of signals on a carrier wave.

Various forms of computer readable media may be involved in carrying one or more sequence of instructions or data or both to processor 602 for execution. For example, instructions and data may initially be carried on a magnetic disk of a remote computer such as host 682. The remote computer loads the instructions and data into its dynamic memory and sends the instructions and data over a telephone line using a modem. A modem local to the computer system 600 receives the instructions and data on a telephone line and uses an infra-red transmitter to convert the instructions and data to a signal on an infra-red carrier wave serving as the network link 678. An infrared detector serving as communications interface 670 receives the instructions and data carried in the infrared signal and places information representing the instructions and data onto bus 610. Bus 610 carries the information to memory 604 from which processor 602 retrieves and executes the instructions using some of the data sent with the instructions. The instructions and data received in memory 604 may optionally be stored on storage device 608, either before or after execution by the processor 602.

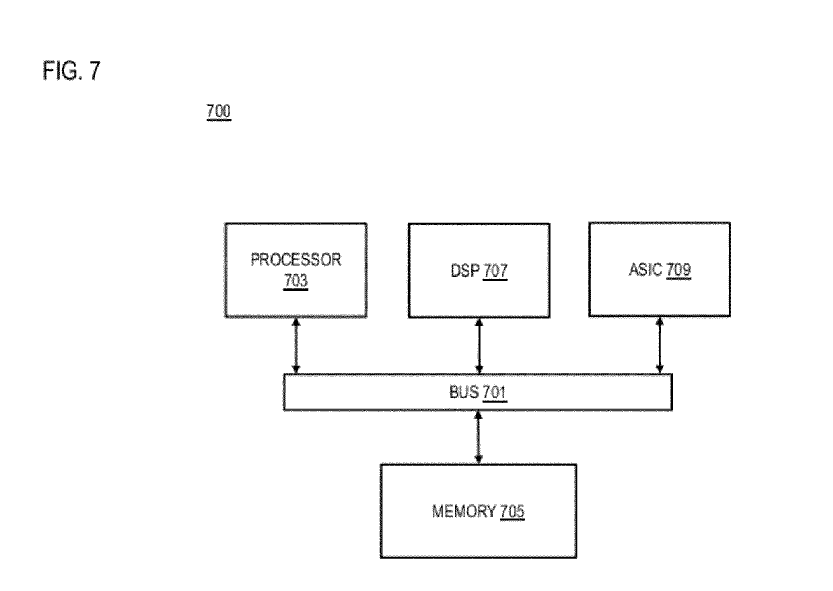

FIG. 7 illustrates a chip set or chip 700 upon which an embodiment of the invention may be implemented. Chip set 700 is programmed to associate content information, such as that related to printed media, with a RF memory tag read for one or more items as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 700 can be implemented in a single chip. It is further contemplated that in certain embodiments the chip set or chip 700 can be implemented as a single “system on a chip.” It is further contemplated that in certain embodiments a separate ASIC would not be used, for example, and that all relevant functions as disclosed herein would be performed by a processor or processors. Chip set or chip 700, or a portion thereof, constitutes a means for performing one or more steps of providing user interface navigation information associated with the availability of functions. Chip set or chip 700, or a portion thereof, constitutes a means for performing one or more steps of associating content information, such as that related to printed media, with a RF memory tag read for one or more items.

In one embodiment, the chip set or chip 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 700 includes merely one or more processors and some software and/or firmware supporting and/or relating to and/or for the one or more processors.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to associate content information, such as that related to printed media, with a RF memory tag read for one or more items. The memory 705 also stores the data associated with or generated by the execution of the inventive steps.

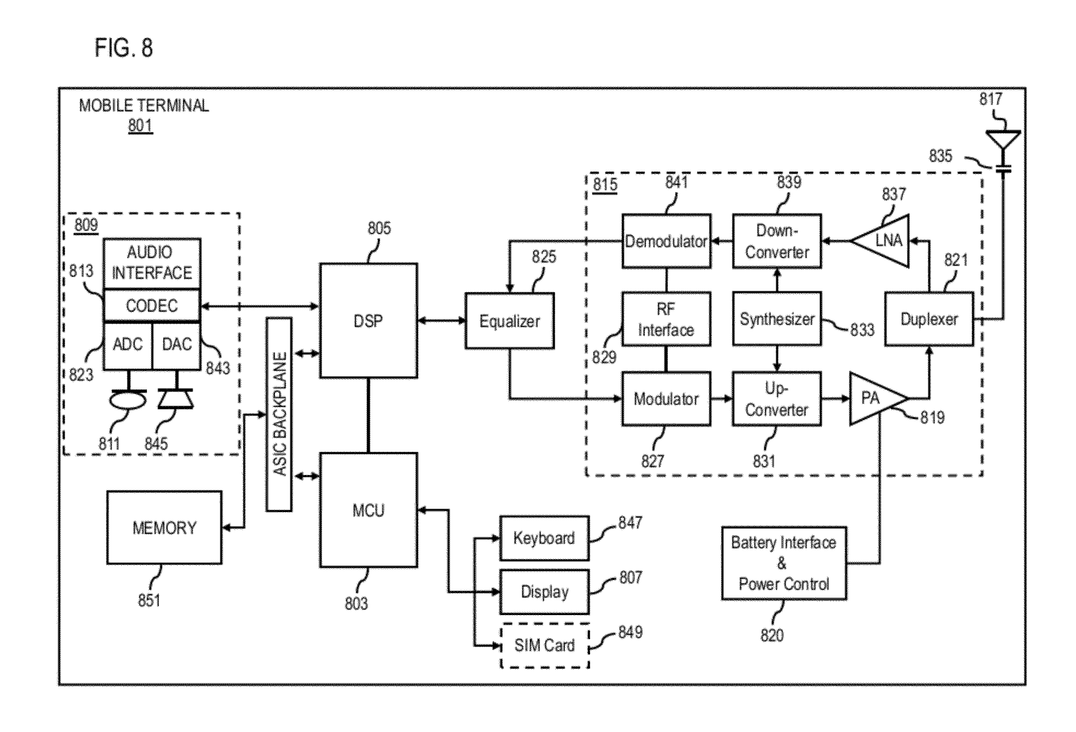

FIG. 8 is a diagram of exemplary components of a mobile terminal (e.g., handset) for communications, which is capable of operating in the system of FIG. 1, according to one embodiment. In some embodiments, mobile terminal 801, or a portion thereof, constitutes a means for performing one or more steps of associating content information, such as that related to printed media, with a RF memory tag read for one or more items. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile terminal functions that perform or support the steps of associating content information, such as that related to printed media, with a RF memory tag read for one or more items. The display 807 includes display circuitry configured to display at least a portion of a user interface of the mobile terminal (e.g., mobile telephone). Additionally, the display 807 and display circuitry are configured to facilitate user control of at least some functions of the mobile terminal. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile terminal 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803 which can be implemented as a Central Processing Unit (CPU) (not shown).

The MCU 803 receives various signals including input signals from the keyboard 847. The keyboard 847 and/or the MCU 803 in combination with other user input components (e.g., the microphone 811) comprise a user interface circuitry for managing user input. The MCU 803 runs a user interface software to facilitate user control of at least some functions of the mobile terminal 801 to associate content information, such as that related to printed media, with a RF memory tag read for one or more items. The MCU 803 also delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the terminal. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile terminal 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile terminal 801 on a radio network. The card 849 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising facilitating a processing of and/or processing (1) data and/or (2) information and/or (3) at least one signal, the (1) data and/or (2) information and/or (3) at least one signal based, at least in part, on the following:
a capture of content information from printed media;
a processing of the content information to determine one or more items; and
at least one determination to present at least a portion of the content information, additional information related to the one or more items, or a combination thereof on reading of one or more radio frequency (RF) memory tags associated with at least one of the one or more items.

2. A method of claim 1, wherein the printed media is associated with one or more other RF memory tags, and wherein the capture of the content information comprises causing, at least in part, reading of the one or more other RF memory tags.

3. A method of claim 2, wherein the capture of the content information further comprises retrieving at least a portion of the content information from one or more links read from the one or more RF memory tags.

4. A method of claim 1, wherein the (1) data and/or (2) information and/or (3) at least one signal are further based, at least in part, on the following:
causing, at least in part, an aggregation of the content information with previously captured content information associated with other printed media,
wherein the at least a portion of the content information, the additional information, or a combination thereof is queried from the aggregation.

5. A method of claim 1, wherein the printed media and the one or more RF memory tags are associated by a common indicator, and wherein the common indicator represents, at least in part, a service provider, a retailer, an advertiser, a brand, or a combination thereof.

6. A method of claim 1, wherein the (1) data and/or (2) information and/or (3) at least one signal are further based, at least in part, on the following:
a reading of the one or more RF memory tags to determine credential information for accessing a communication network,
wherein the at least a portion of the additional information is retrieved over the communication network.

7. A method of claim 1, wherein the (1) data and/or (2) information and/or (3) at least one signal are further based, at least in part, on the following:
an association between the content information and the one or more RF memory tags; and
at least one determination to initiate an action, wherein the action includes at least in part initiating a purchase, initiating a payment, initiating an Internet query, initiating a comparison, initiating a presentation of a media file, determining availability of the one or more items or other items, reserving the one or more items or other items, creating a reminder for a delayed action, or a combination thereof.

8. A method of claim 1, wherein the (1) data and/or (2) information and/or (3) at least one signal are further based, at least in part, on the following:
profile information from one or more social networks, the profile information associated with a device reading the one or more RF memory tags, a user of the device, one or more other devices within the one or more social networks, one or more other users associated with the one or more other devices, or a combination thereof,
wherein the at least a portion of the content information, the additional information, or a combination thereof is based, at least in part, on the profile information.

9. A method of claim 1, wherein the (1) data and/or (2) information and/or (3) at least one signal are further based, at least in part, on the following:
context information associated with a device reading the one or more RF memory tags, a user of the device, the printed media, the one or more items, the one or more RF memory tags, or a combination thereof,
wherein the at least one portion of the content information, the additional information, or a combination thereof is based, at least in part, on the profile information.

10. A method of claim 1, wherein different portions of the content information, the additional information, or a combination thereof are presented on successive readings of the one or more RF memory tags.

11. An apparatus comprising:
at least one processor; and
at least one memory including computer program code for one or more programs,
the at least one memory and the computer program code configured to, with the at least one processor, cause the apparatus to perform at least the following,
cause, at least in part, a capture of content information from printed media;
process and/or facilitate a processing of the content information to determine one or more items; and
determine to present at least a portion of the content information, additional information related to the one or more items, or a combination thereof on reading of one or more radio frequency (RF) memory tags associated with at least one of the one or more items.

12. An apparatus of claim 11, wherein the printed media is associated with one or more other RF memory tags, and wherein the capture of the content information comprises causing, at least in part, reading of the one or more other RF memory tags.

13. An apparatus of claim 12, wherein the capture of the content information further comprises retrieving at least a portion of the content information from one or more links read from the one or more RF memory tags.

14. An apparatus of claim 11, wherein the apparatus is further caused to:
cause, at least in part, an aggregation of the content information with previously captured content information associated with other printed media,
wherein the at least a portion of the content information, the additional information, or a combination thereof is queried from the aggregation.

15. An apparatus of claim 11, wherein the printed media and the one or more RF memory tags are associated by a common indicator, and wherein the common indicator represents, at least in part, a service provider, a retailer, an advertiser, a brand, or a combination thereof.

16. An apparatus of claim 11, wherein the apparatus is further caused to:
cause, at least in part, a reading of the one or more RF memory tags to determine credential information for accessing a communication network,
wherein the at least a portion of the additional information is retrieved over the communication network.

17. An apparatus of claim 11, wherein the apparatus is further caused to:
determine an association between the content information and the one or more RF memory tags; and
determine to initiate an action, wherein the action includes at least in part initiating a purchase, initiating a payment, initiating an Internet query, initiating a comparison, initiating a presentation of a media file, determining availability of the one or more items or other items, reserving the one or more items or other items, creating a reminder for a delayed action, or a combination thereof.

18. An apparatus of claim 11, wherein the apparatus is further caused to:
determine profile information from one or more social networks, the profile information associated with a device reading the one or more RF memory tags, a user of the device, one or more other devices within the one or more social networks, one or more other users associated with the one or more other devices, or a combination thereof,
wherein the at least a portion of the content information, the additional information, or a combination thereof is based, at least in part, on the profile information.

19. An apparatus of claim 11, wherein the apparatus is further caused to:
determine context information associated with a device reading the one or more RF memory tags, a user of the device, the printed media, the one or more items, the one or more RF memory tags, or a combination thereof,
wherein the at least one portion of the content information, the additional information, or a combination thereof is based, at least in part, on the profile information.

20. An apparatus of claim 11, wherein different portions of the content information, the additional information, or a combination thereof are presented on successive readings of the one or more RF memory tags.
